(19) United States
(12) Patent Application Publication
(10) Pub. No.: US 2020/0277880 A1
(43) Pub. Date: Sep. 3, 2020

(54) System and Method for Geothermal Power Generation Using a Closed-Loop of Liquid having Low Boiling Temperature

(71) Applicants: Remez Lev Ari, Herzliya (IL); Yaron Virtzer, Ramat HaSharon (IL); Vladimir Kogan, Rehovot (IL); Shiri Carmielli, Ness Ziona (IL)

(72) Inventors: Remez Lev Ari, Herzliya (IL); Yaron Virtzer, Ramat HaSharon (IL); Vladimir Kogan, Rehovot (IL); Shiri Carmielli, Ness Ziona (IL)

(21) Appl. No.: 16/290,912

(22) Filed: Mar. 3, 2019

(51) Int. Cl. F01K 21/04; F01K 25/06; F01K 7/16; F01D 15/10

(52) U.S. Cl. CPC F01K 21/04; F01K 25/06; F24T 50/00; F01D 15/10; F01K 7/16

(57) ABSTRACT

Systems and methods for geothermal power generation using a closed-loop of liquid having low boiling temperature. A system for generating electricity includes: a storage tank to store a specific liquid, which has a boiling point of under 90 degrees Celsius; a closed-loop pipe sub-system, which penetrates underground to a depth of between 1,000 to 2,500 meters, and transports therein the specific liquid downwardly underground and then upwardly back towards ground level, and causes at least a portion of the specific liquid to boil underground due to proximity to a natural geothermal heat source; at least one turbine associated with an electric power generator, connected above ground level to the closed-loop pipe sub-system, to receive steam that results in from underground boiling of the specific liquid, to pass the steam through the turbine, and to generate electric power through the electric power generator

### FIELD

The present invention is related to the field of power generation.

### BACKGROUND

Millions of people worldwide utilize electric devices and appliances on a daily basis. Some of these devices are powered by an internal battery or power cell. Other devices receive electric power from an electric outlet or socket, which in turn receives electric power over a conducting wire from a remote power plant or power station.

As the demand for electric devices increases, and as new types of electric devices are introduced and are utilized by individual consumers and business entities alike, there is an increased demand for electric power. Owners or operators of power plants use various ways to produce electric power; for example, based on combustion of liquid fuels (e.g., petroleum), combustion of solid fuels (e.g., coal), by using solar panels or photovoltaic panels, by using wind-based energy production systems, or the like.

### SUMMARY

The present invention may include, for example, systems, devices, and methods for power generation using a closed-loop of liquid having low boiling temperature.

For example, a geothermal system for generating electricity includes: (a) a storage tank to store a specific liquid, which has a boiling point of under 90 degrees Celsius; (b) a closed-loop pipe sub-system, which penetrates underground to a depth of between 1,000 to 2,000 (or 2,500) meters, and transports therein the specific liquid downwardly underground and then upwardly back towards ground level, and causes at least a portion of the specific liquid to boil underground due to proximity to a natural geothermal heat source; (c) at least one turbine associated with an electric power generator, connected above ground level to the closed-loop pipe sub-system, to receive steam that results in from underground boiling of the specific liquid, to pass the steam through the turbine, and to generate electric power through the electric power generator. The storage tank and the turbine are implemented as integral and internal parts of the closed-loop pipe sub-system. An injector may inject the specific liquid into or towards the underground pipe sub-system. A steam collector may collect steam incoming to the ground level due to the underground boiling of the specific liquid, and may divert or route the steam to pass through the one or more turbines. The steam output from the last turbine is routed back towards the storage tank, for re-cycling and re-use as liquid, repeatedly and continuously.

The present invention may provide other and/or additional benefits or advantages.

### BRIEF DESCRIPTION OF THE DRAWINGS

FIG. 1 is a schematic block-diagram illustration of a system, in accordance with some demonstrative embodiments of the present invention.

FIG. 2 is a schematic block-diagram illustration of a chart demonstrating the vapor pressure that may be generated for seven different materials at as a function of temperature, in accordance with some demonstrative embodiments of the present invention.

### DETAILED DESCRIPTION OF SOME DEMONSTRATIVE EMBODIMENTS

The present invention includes, for example, systems, devices, and methods for power generation using a closed-loop of liquid having low boiling temperature. The present invention provides a power plant capable of generating energy based on geothermal resources and/or capable of increasing energy production by improving efficient utilization of geothermal energy and/or geothermal resources.

In accordance with the present invention, a low boiling medium (e.g., a particular liquid that boils at a relatively low temperature) is used in a closed loop geothermal power plant or in a power generation facility.

The Applicants have realized that some conventional geothermal energy plants require the utilization of geothermal reservoirs exclusively in particular geographical locations where the Earth crust is relatively thin, and high temperature within the ground is used to heat underground water; and the heat of the hot underground water is then utilized by a heat exchanger to generate high-temperature steam, which turns a turbine that generates electric power. The Applicants have realized that few and/or far and/or rural geographical locations are suitable for such conventional system, often far from population centers or urban areas (e.g., particularly in or near regions that are prone to volcanic activity); and require deep drilling (e.g., to a depth of at least 5,000 meters) using costly equipment and hazard-prone process.

In contrast, the closed-loop geothermal power plant of the present invention utilizes a medium (e.g., a liquid, or mixture or combination of certain liquids) having a low boiling point; thereby enabling to locate, construct and efficiently operate the geothermal power plant virtually anywhere on Earth, and/or with sufficiency to drill to much smaller depth (e.g., around 1,500 or 1,800 or 2,000 or 2,500 meters), while still achieving or reaching boiling temperature for that particular medium to generate vapors which turn into a high-pressure steam which then rotates or spins or moves or powers a turbine or other mechanical element (blades, rotating elements, spinning elements) which is connected to an electric power generator that generates electricity or electric power.

The geothermal power generation system of the present invention utilizes a single closed loop, or optionally, multiple separate closed loops which are separate from each other, such as, implemented in parallel to each other; and therefore does not pollute the environment, or creates zero pollution while harnessing geothermal energy and/or geothermal resources.

The Applicants have also realized that conventional power plants require extensive cooling systems, often by using sea water, which in turn further constrains the relevant location for constructing and operating a power plant or a geothermal power plant. In contrast, since the present invention uniquely utilizes a closed loop of liquid(s) having low boiling temperature, the cooling requirements and cooling expenses may be significantly mitigated or reduced, and/or less cumbersome or smaller or less costly cooling systems or cooling processes may be used; and in some embodiments, a cooling tower may be entirely unnecessary and need not be constructed, maintained or used. For example, since the vapor pressure of the particular liquid utilized by the present invention is approximately twice relative to that of water (e.g., at 45 degrees Celsius), the system of the present invention may generate additional electric power by replacing the cooling system of a power plant (or at least portions of such cooling system) with additional closed-loop elements or turbines or generators. In a demonstrative implementation of the present invention, in which the liquid reaches temperature of 80 degrees Celsius, an electric energy output may be generated at four times the amount of electric power that is generated by a conventional water-based geothermal power plant having the same temperature.

Furthermore, in contrast to conventional geothermal energy plants, the geothermal energy generation system of the present invention utilizes a closed loop which, for example, increases the efficiency by several times, and/or reduces risks and hazards (e.g., associated with a conventional heat exchange that typically contains or utilizes an explosive gas).

The present invention utilizes underground heat to increase the temperature and to heat up a low-boiling medium which in turn generates steam power for electricity production.

The Applicants have realized that with the rapid consumption of non-renewable resources of oil and natural gas, development and utilization of new energy sources, particularly renewable energy, may be beneficial and advantageous. The Applicants have also realized that geothermal resources, which occur underground or which are located underground, include clean mineral resources which can be harnessed for clean energy production. For example, the heat in Earth's core is estimated to be equivalent to 44 trillion of watts/year; and harnessing even a small portion of such resource may meet most of the world's energy requirements.

The Applicants have realized that based on geological data, the temperature of geothermal resources may be divided into three types: high temperature (e.g., over 150 degrees Celsius), medium temperature (e.g., in the range of 90 to 150 degrees Celsius), low temperature (e.g., under 90 degrees Celsius). The Applicants have realized that conventional geothermal power plants necessarily require and use, exclusively, only high and medium temperature geothermal resources; and as a result, such conventional geothermal plants must necessarily be located at specific or particular geographic locations where there exists a suitable geothermal reservoir and/or where the Earth crust is thin. The Applicants have also realized that such locations are typically near or within active volcanic regions, which in turn imposes a major risk or safety hazard; and also limits the relevant or available locations for constructing or operating such geothermal power plants. The Applicants have realized that as a result, conventional geothermal power plants are not widely spread, and/or are sparse and/or are located in high-risk areas or in dangerous areas; and their remote or rural or non-urban locations further require expensive or costly infrastructure for power delivery and/or power distribution towards populated areas or urban areas.

The present invention solves, mitigates, avoids and/or eliminates the problems discussed above, or at least some of them; by uniquely utilizing and a low boiling medium that requires low temperatures (which may be available at virtually any place on Earth by reduced-depth drilling), and may thus utilize and harness the low geothermal heat of low temperature geothermal resources to boil the medium and generate steam power which in turn spins or rotates a turbine (or other mechanical unit), and the kinetic energy is then converted into electric energy or electricity.

The Applicants have realized that coal, natural gas, and petroleum continue to be leading sources of energy production in the United States as well as in other countries (e.g., natural gas is approximately 30%, petroleum is around 36%, coal is around 16%, and conventional geothermal power plants are less than 0.2%); and that it is important or even essential to explore alternative and/or clean energy sources to meet society's growing energy needs. The unique closed-loop electricity production system of the present invention, which may be implemented as numerous geothermal facilities that may be located virtually anywhere, the United States (as well as other countries) may continue to generate and supply electricity to consumers without the high costs associated with the current modes of energy production and/or while reducing costs of power distribution (since, for example, the electric power generation system of the present invention may be constructed and operated within a city or a town, or near a city or a town, or in urban or populated areas, or in non-volcanic areas or non-rural areas, or in proximity to a batch or group of consumers, or the like).

The system of the present invention includes, for example: a storage tank to store the low boiling temperature medium; a closed loop pipe or tube which penetrates underground at a first place and comes out of the ground at a second place (e.g., nearby); a steam collector; and a steam-based turbine generator or a set of such turbine generators. The storage tank outlet is connected to the underground pipe; the pipe outlet is connected to a steam collector; the steam collector outlet is connected to steam turbine generators which are optionally connected one after the other.

In system of the present invention, the storage tank is placed and remains above ground, and is connected to the closed-loop pipe which goes underground and comes back or returns subsequently above ground. The low boiling medium is injected or inserted or pumped into (or flows towards, or through) the underground portion of the closed-loop pipe; the medium absorbs geothermal heat as it travels underground; the medium boils while still being underground and/or immediately prior to arriving back to above ground level, such that the medium returns to ground level as vapor or as steam or as gas. The pipe outlet of the closed-loop system is connected to a steam collector; and the returned steam is collected there. The steam collector outlet is connected to the steam turbine generator(s), and the steam pressure (e.g., high pressure, or even medium pressure) is then released and powers one or more, or several, generators which may be connected or placed or mounted one after the other. In some embodiments, the steam collector may comprise a separator unit, or may operate as a separator, in order to collect only the steam and separate it from cold liquid (which is returned or routed directly to the storage tank).

In some embodiments, the liquid vapors from the steam collector are recycled and routed back to the storage tank. This applies to the low temperature geothermal heat, such as, around 50 degrees Celsius. The high steam pressure of the low boiling medium is sufficiently large, so that pressure and heat can be successively provided for the turbine generator even without the colder liquid which can be directly recycled in the system. In the above example, low temperature geothermal heat or geothermal temperature may be up to 55 degrees Celsius; and a suitable medium may be dichloromethane (e.g., having a boiling point at normal pressure of 39.6 degrees Celsius).

As the hot medium travels through the turbines over the ground it loses its heat and is cooled down; and the cooled medium or the cold medium is then collected back into the storage tank over the ground, and is then injected or pumped or transferred again to the underground pipe portion of the closed-loop system. During this closed-loop process, no portion of the medium is lost, nor does it leak or disappear or escape; and the entire original quantity of medium remains and is re-used in the closed-loop system.

Some embodiments of the present invention may be implemented using the following components and demonstrative process of operations. (a) A storage tank stores (e.g., at ground level) a particular liquid, selected from a group of liquids listed herein below, which has a low boiling point (e.g., under 90 degrees Celsius). (b) The liquid is pumped or injected or transferred from the storage tank, at high pressure or using injection or pumping operations, into an underground segment of a closed-loop pipe. (c) The injected liquid travels downwardly into the Earth, along a vertical depth of approximately 1,000 or 1,300 or 1,500 or 1,800 or 2,000 meters or up to 2,500 meters; heats up due to the fact that the ambient temperature at such depths is higher than ground level temperature; and then it changes direction (e.g., via a “U” shaped pipe) and returns upwardly towards the ground level. (d) As the heated liquid reaches the surface, the pressure is dropped, which causes the liquid (having a low boiling point) to turn into high-pressure steam. (e) The high-pressure steam spins a turbine (or other rotary mechanical device) which is connected to an electricity generator that produces electricity or electric power. (f) The high-pressure steam continues to flow with a suitable pipe to another turbine (e.g., second turbine, third turbine, and so forth), and each one of those additional turbines is similarly associated with or connected to an electric power generator that produces electricity. (g) After the steam spins several such turbines in series, one after the other, the steam cools down and becomes liquid again due to the low boiling point of the material used. (h) The liquid is then re-used and re-cycled through the closed-loop pipe, by being pumped or injected back at high pressure into the underground segment of the close-loop pipe; and the above-mentioned operations are repeated continuously.

In accordance with the present invention, the medium or liquid having low boiling point temperature, may be or may comprise one of the following, and/or may comprise a combination or mixture of two or three or more of the following: dichloromethane or DCM or methylene chloride (e.g., having a boiling point of 39.6 degrees Celsius); ethanol or ethyl alcohol or EtOH (e.g., having a boiling point of approximately 78.24 degrees Celsius); acetone or propanone (e.g., having a boiling point of 56.05 degrees Celsius); 1-pentene (e.g., having a boiling point of 30 degrees Celsius); isopentane or methylbutane or 2-methylbutane (e.g., having a boiling point in the range of 27.8 to 28.2 degrees Celsius); pentane (e.g., having a boiling point in the range of 35.9 to 36.3 degrees Celsius); ether or ethyl ether or diethyl ether (e.g., having a boiling point of 34.6 degrees Celsius); ethylene oxide or oxirane (e.g., having a boiling point of 10.4 degrees Celsius); ethyl chloride or chloroethane or monochloroethane (e.g., having a boiling point of 12.27 degrees Celsius); methyl Tert-Butyl ether or MTBE or Tert-Butyl methyl ether (e.g., having a boiling point of approximately 55 degrees Celsius); propylene oxide or 2-Methyloxirane (e.g., having a boiling point of approximately 35 degrees Celsius); and/or other liquid or medium having a low or relatively low boiling point (e.g., boiling point of under 90 degrees Celsius), particularly if such medium also meets a requirement of having high or medium vapor-pressure at low temperature. In accordance with the present invention, the liquid(s) and/or material(s) that are inserted or injected into the closed-loop pipe system, and/or that travel through it as liquid and/or as steam or vapors or gas, and/or that pass through the steam collector and/or the turbines, and/or that are stored in the storage tank, are materials or liquids that are environmentally friendly (“green”) and that do not cause harm or damage or adverse effects or negative effects to nature or people or animals; and are non-toxic, non-poisonous, non-explosive, non-flammable, and are regarded as being generally safe or harmless or bio-friendly or non-harmful or non-polluting.

In some embodiments, the steam collector operates to separate the gaseous vapors from the liquid vapors; such that, for example, gaseous vapors are directed towards the turbines, whereas liquid vapors may be directed back to the storage tank for re-use (e.g., through direct recycle line(s), and/or without firstly passing through the turbines). The steam collector is connected to the inlet of the steam turbine generator, which in turn has an outlet that is connected to a low-pressure turbine generator; multiple such turbines and generators may be connected in series or in a chain arrangement, one after the other, such that the medium passes through them serially until the medium has cooled down (e.g., below its boiling point) and is re-injected or re-transferred into the underground portion of the closed-loop system to cycle through it again and again.

The Applicants have realized that conventional geothermal power stations are constructed and operate, and can only be constructed and operate, in particular “hot spot” locations or areas; for example, regions of volcanic activity; and require deep drilling to depths of 5,000 meters, so that water can travel to such significant depth, boil there, and release steam that can then be utilized for power production; typically with powerful pumps that are then used in order to pump upwardly the water from the depth in which they boiled. The Applicants have also realized that it is very difficult to locate such “hot spots”, and they are rare to find, hard to find, and typically located at isolated or rural or non-urban areas or volcanic areas; and that the odds of finding such “hot spot” for a conventional geothermal facility are low or even minuscule. In contrast, the system of the present invention utilizes, instead of water, a liquid having a low boiling point (e.g., less than 90 or 80 or 70 or 60 or even 50 degrees Celsius), thereby enabling to construct a unique geothermal system that reaches only a depth of up to 2,000 or 2,500 meters deep (instead of approximately 5,000 meters deep), as such reduced depth (which is not sufficient to cause water to boil underground) is sufficient to provide sufficient heat to cause such special liquid to boil underground. The Applicants have realized that every 100 meters of depth of drilling, may provide an increase of the surrounding temperature by approximately 1 or 2 or even 3 degrees Celsius. In a demonstrative example, the temperature at ground level may be 20 degrees Celsius; the pipe system of the present invention is drilled to a depth of 2,000 meters; each 100 meters of depth increases the temperature, on average, by 2 degrees Celsius; and therefore, the 2,000 meters of depth contribute an aggregate increase of the surrounding temperature by 20×2=40 degrees Celsius; which, together with the initial or “base” temperature of the ground level (20 degrees Celsius in this example) reaches together an underground temperature of 60 degrees Celsius; which is far from the boiling point of water, and is insufficient to boil water underground at such depth; but is sufficient to boil other liquid(s) that are enumerated herein, and is sufficient to cause them to turn into steam which then climbs upwardly back towards ground level and passes through power-generating turbines. Therefore, by using the low boiling point liquid, in combination with reduced depth drilling in the range of 1,000 to 2,000 meters only (or, in some implementations, up to 2,500 meters deep), the system of the present invention is capable of efficiently generating steam for electricity generation; and such steam, produced via such reduced depth of drilling and via such reduced boiling temperature, may spin or rotate power-generating turbines not less effectively, and actually even more effectively, compared to water that boil at 100 degrees Celsius and require much greater depth of drilling. Accordingly, the system of the present invention utilizes the difference and particularly the increase in the surrounding temperature that is achieved even by such reduced depth drilling of 1,000 to 2,000 meters only (or, in some implementations, up to 2,500 meters deep), which suffices to boil underground the low boiling point liquid and to efficiently create the steam which then spins the power-generating turbines. The system of the present invention is not limited to, and does not require to, be located at “hot spot” of volcanic activity or in proximity to a deeply buried geothermal reservoir (which is rare and hard to find); but rather, utilizes the natural increase in surrounding temperature that occurs at virtually any location on Earth, and enables to construct and operate the system of the present invention virtually anywhere.

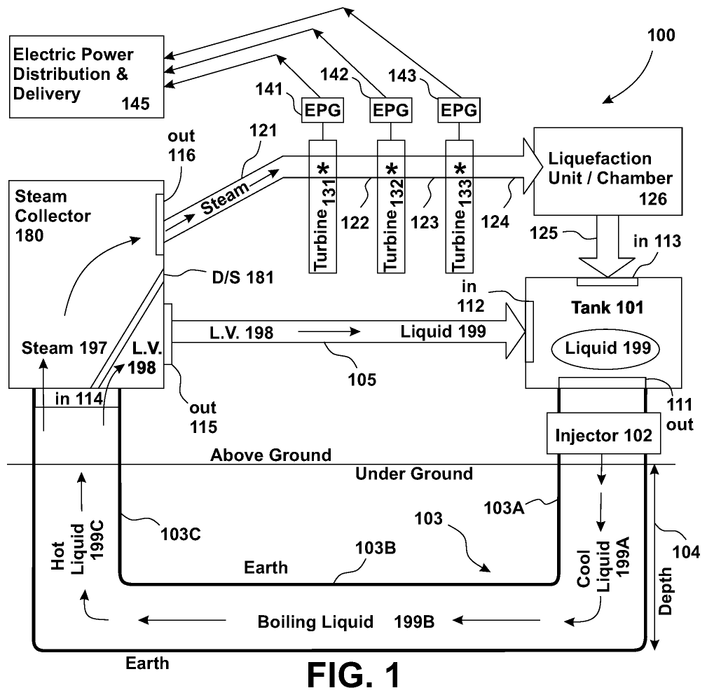

Reference is made to FIG. 1, which is a schematic block-diagram illustration of a system 100, in accordance with some demonstrative embodiments of the present invention. System 100 may comprise a storage tank 101 and a closed-loop sub-system comprising multiple components as well as tubes or pipes (103, 121-125). It is clarified that the components of system 100 are not drawn to scale, or are drawn to be exaggeratedly larger or smaller than their real-life dimensions; for example, the underground depth of the underground pipes sub-system may reach underground depth of between 1,000 to 2,500 meters, whereas the storage tank 101 may have dimensions in the order of magnitude of several meters or several dozens of meters, even though both the storage tank 101 and the underground pipes sub-system 103 appear in the drawing as having similar size.

Storage tank 101 may store a material, or a combination or mixture of materials, from the list of specific materials that are mentioned above. Storage tank 101 may be at ground level or above the ground, such that the specific material inside storage tank 101 is in liquid form and is referred to as liquid 199. In a demonstrative embodiment, storage tank may store, for example, approximately 100,000 liters or approximately 500,000 liters or approximately 1,000,000 liters or approximately 3 or 5 or 8 or 10 million liters of liquid 199, or may store an amount of liquid 199 in the range of 100,000 to 10 million liters.

An injector 102, or a suitable injecting mechanism or liquid transfer unit or a pump or a pressure pump or a pressure injector, obtains or receives or gets a pre-defined amount of liquid 199 from (or through) an exit outlet 111 of storage tank 101, and injects it or pushes it or pumps it downwardly towards or into an underground pipe sub-system 103. For example, in a demonstrative embodiment, injector 102 may obtain or receive from storage tank 101 a portion of liquid 199 (e.g., discrete batches of 1 or 3 or 5 or 10 percent of the full liquid amount that is in the system; or particular pre-defined amount(s) of liquid that are measured in liters or in other units; and may inject or pump it downwardly into the underground pipe sub-system 103 at a suitable injection force that would suffice (e.g., by itself, and/or in combination with the gravitational force) to cause the liquid to travel down.

Underground pipe sub-system 103 may be generally “U” shaped, and may comprise multiple components or segments; for example, a first generally-vertical pipe segment 103A, then a second generally-horizontal pipe segment 103B, then a third generally-vertical pipe segment 103C. The underground depth of the underground pipe sub-system 103 is shown with an arrow 104; and such underground depth (or, the underground depth that pipe segment 103A and/or 103B and/or 103C reach) may be, for example, 1,000 or 1,200 or 1,400 or 1,500, or 1,600 or 1,800 or 2,000 or 2,200 or 2,400 or 2,500 meters, or may be under 2,500 meters, or may be under 2,200 meters, or may be under 2,000 meters, or may be 2,000 meters, or may be under 1,800 meters, or may be under 1,500 meters, or may be 1,500 or 1,250 or 1,000 meters, or may be in the range of 1,000 to 2,500 meters deep, or may be in the range of 1,500 to 2,500 meters deep, or may be in the range of 1,000 to 2,000 meters deep, or may be in the range of 1,500 to 2,000 meters deep, or may be not more than 2,500 meters deep, or may be not more than 2,400 meters deep, or may be not more than 2,300 meters deep, or may be not more than 2,200 meters deep, or may be not more than 2,100 meters deep, or may be not more than 2,000 meters deep, or may be not more than 1,900 meters deep, or may be not more than 1,800 meters deep, or may be not more than 1,700 meters deep, or may be not more than 1,600 meters deep, or may be not more than 1,500 meters deep, or may be not more than 1,400 meters deep, or may be not more than 1,300 meters deep, or may be not more than 1,200 meters deep, or may be not more than 1,100 meters deep, or may be not more than 1,000 meters deep, or may be in a range of between A and B wherein A is any particular number mentioned above and wherein B is any particular other number mentioned above.

As liquid 199 travels through the underground pipe sub-system 103, liquid 199 gradually changes its temperature and/or its state. Generally, the travel of liquid 199 downwardly along pipe segment 103A towards the center of Earth exposes liquid 199 to increasing or higher ambient temperatures or environmental temperature or surrounding temperature (e.g., even without being in proximity to any volcanic region and/or to any geothermal reservoir); whereas, the travel of liquid 199 upwardly along pipe segment 103C away from the center of Earth exposes liquid 199 to decreasing or lower ambient temperatures or environmental temperature or surrounding temperature. For example, pipe segment 103A may transfer or transport downwardly the liquid 199 at a state of a cool liquid 199A; then, pipe segment 103B, which is located at the underground depth indicated by arrow 104, transfers or transports it further as a boiling liquid 199B, or as a liquid that is about to reach boiling point, or as a liquid that has just reached and/or passed its boiling point, and the length or the horizontal length of pipe segment 103B may be, for example, approximately 1 meter or approximately 10 meters or approximately 50 or 100 meters or approximately 500 or 1,000 meters or approximately 2,000 or 3,000 or 4,000 or 5,000 meters or may be in the range of any two of the above-mentioned numbers; then, pipe segment 103C transfers or transports it upwardly back towards ground level, as a hot liquid 199C which optionally may have already boiled and/or may have already converted from liquid state to gas state or to vapors or to steam.

The underground pipe sub-system 103 enters into a steam collector 180 through an inlet 114. The steam collector 180 may be located at ground level, or above ground level. Optionally, the steam collector 180 may comprise a Divider/Separator unit 181 (denoted as D/S 181 in the drawing), which may optionally divide or divert or separate the material incoming upwardly from the underground pipe sub-system 103 into two parts: (i) Liquid Vapor 198 (denoted L.V. 198 in the drawing), and (ii) steam 197.

The liquid vapors 198 may exit the steam collector 180 through an outlet 115, and may be transported along a pipe 105 (which may be referred to as a “shortcut” pipe or a diverting pipe or a liquid-diverting pipe), and may optionally cool down along their travel through pipe 105 and become liquid again, such that they may enter (e.g., as liquid vapors 198, and/or as liquid 199) back into the storage tank 101 through its inlet 112.

In contrast, the steam 197 that is collected at the steam collector 180, is further utilizes by the system for electric power production. For example, the steam 197 exits the steam collector 180 through an outlet 116, and is transported or transferred along a pipe 121 towards and then through a set of turbines 131-133 that are associated, respectively, with a set of Electric Power Generators (EPGs) 141-143. For example, the steam 197 travels along pipe 121 and spins or rotates or moves the first turbine 131, and the first EPG 141 converts such kinetic energy of the first turbine into electric power. Then, the steam 197 continues to travel along a pipe 122 from the first turbine 131 to the second turbine 132, and spins or rotates or moves the second turbine 132, and the second EPG 142 converts such kinetic energy of the second turbine into electric power. Then, the steam 197 continues to travel along a pipe 123 from the second turbine 132 to the third turbine 133, and spins or rotates or moves the third turbine 133, and the third EPG 143 converts such kinetic energy of the third turbine into electric power.

For demonstrative purposes, three turbines 131-133 and three respective EPGs are shown 141-143; however, in some embodiments, a single turbine may be used with a single EPG, or two turbines may be used with two respective turbines, or another number of turbines may be used together with a respective number of EPGs.

For demonstrative purposes, the three turbines 131-133 are shown as being in-line or in series relative to each other; however, other suitable arrangements may be used. For example, in some embodiments, the steam 197 may be routed, transported or transferred along linear or non-linear or curved pipes or tubes, from a turbine to a next turbine. In some embodiments, optionally, steam 197 exiting from the first turbine 131, may be divided via a divider unit to two (or more) steam flows, such that a first steam flow is transported via a first pipe towards turbine 132, whereas a second steam flow is transported separately via a second pipe towards turbine 133; and the steam outputs of the two turbines 132-133 may later be combined again, or may later continue their transport as two separate steam flows. Other suitable arrangements may be used.

The steam that flows out of the last turbine(s) or that exits the last turbine(s), is transported or transferred to, or towards, the storage tank 101, either directly or indirectly. In some embodiments, for example, such steam which exits the last turbine 133 is transported through a pipe 124 into an optional Liquefication Unit/Chamber 126, which in turn may operate to liquefy the steam or to change the state of such steam from steam to liquid; for example, by slightly reducing the temperature that the steam is exposed to, or by slightly reducing the ambient temperature to be under the boiling point of liquid 199; and the Liquefication Unit/Chamber 126 then transfers such liquid 199 to the storage tank 101 through its inlet 113. In other embodiments, the Liquefication Unit/Chamber 126, but rather, the steam 197 that exits the last turbine(s) may be transported back directly to inlet 113 of the storage tank 101, via a set of pipes (e.g., pipes 124 and 125 but directly connected to each other, without the Liquefication Unit/Chamber 126); and the mere transport of the steam 197 through such pipes may cause the steam 197 to liquify, particularly if they are sufficiently long and/or they are in an area having ambient temperature below the boiling point of liquid 199; such that by the time of arrival at the inlet 113 of storage tank 101, the steam 197 has already converted back to liquid 199 and enters the storage tank 101 as liquid. In some embodiments, optionally, the inlet 113 of storage tank 101 may receive or may accept both liquid input and steam or vapors or gas input, such that any remaining steam or vapor or gas that did not yet liquify on its way towards the storage tank 101 may later liquify within the storage tank 101. Other suitable transport mechanisms may be used with regard to transporting the output of the last turbine(s) to the storage tank 101.

The above-mentioned cycle of liquid 199 (which becomes steam 197 for parts of its journey) may be repeated continuously, such as in a generally continuous closed loop or closed cycle; without losing or discarding any portion of the liquid 199, and/or without having such liquid 199 leak or escape out of the closed loop.

The EPGs 141-143 may provide the electric power that they generate to an electric power distribution & deliver sub-system 145, which in turn may distribute and deliver electricity to consumers, such as over conducting wires or cables.

In some embodiments, pipe segments 103A and/or 103B and/or 103C, or at least pipe segment 103B, is formed of material(s) that efficiently transfer or conduct heat, or that have high thermal conductivity; for example, metals, iron, steel, stainless steel, aluminum, or the like. In some embodiments, one or more of the segments of the underground pipe sub-system 103 may be formed of one or more materials which are suitable for geothermal applications, and particularly from heat conducting materials, and not from heat isolating materials.

In some embodiments, the inner diameter or the average inner diameter of the pipes of the underground pipe sub-system 103 may be, for example, approximately 20 or 30 or 40 or 50 or 75 or 100 or 130 or 150 or 180 or 200 centimeters; other suitable values or ranges of values may be used. In some embodiments, the diameter or the average inner diameter of the pipes that transport the steam 197 above the ground (e.g., to or from a turbine) may be, for example, approximately 20 or 30 or 40 or 50 or 75 or 100 or 130 or 150 or 180 or 200 centimeters; other suitable values or ranges of values may be used.

For demonstrative purposes, pipe segment 103B is shown in the drawing as a generally-vertical pipe segment; however, in some implementations, pipe segment 103B, or at least portions thereof, may be slanted or diagonal, or may even be curved or non-linear, such as to facilitate the travel of the liquid 199 through pipe segment 103B with the aid of gravity, or to allow a pipe-segment to travel around an underground obstacle (e.g., hard rock that is difficult to drill through). For demonstrative purposes, pipe segments 103A and 103C are shown in the drawing as being generally-vertical; however, in some embodiments 103A and/or 103C, or at least portions thereof, may be slanted or diagonal, or may even be curved or non-linear; for example, to allow a pipe-segment to travel around an underground obstacle (e.g., hard rock that is difficult to drill through).

In some embodiments, system 100 may comprise or may utilize other and/or additional components or units, which are not shown in order to not over-crowd the drawing and/or in order to not obscure some of the features of the present invention. For example, in some embodiments, a controller or control unit or a computerized sub-system may be included in system 100, to control or regular or modify or configure the operation of the injector 102, and/or the opening and/or closing of one or more of the outlets or inlets of the system (e.g., using one or more valves or opening/closing mechanisms), and/or in order to pause or stop or resume the closed-loop system (e.g., to allow maintenance, or to allow modifications of the system, or to allow prevention or handling of a leakage or a malfunction), and/or to increase or decrease the amount of liquid that travels through the closed-loop pipe system in order to regulate or modify the amount of electric power that is generated and/or to increase or decrease the pressure of the liquid that travels through the closed-loop pipe system and thus affect accordingly or control the amount of electric power that is generated, and/or to control other operational aspects of the system.

In some embodiments, the storage tank of the closed-loop system may perform one or more particular functions, which may include, for example: (a) storing the specific liquid, prior to its injection into the underground segment of the closed-loop pipe system, and/or after it exited from (or passed through) the last turbine; (b) optionally storing both the special liquid in its liquid state, and also a portion of that material in gas state or as vapors or steam that did not yet cool down sufficiently to liquefy, and serving as a storage unit that allows such gas or vapors or steam to cool down and to liquefy again prior to being injected into the underground segment of the closed-loop pipe system; (c) to collect the liquid, or to even collect and store the entirety of the liquid, for example, in order to allow maintenance operations or modification operations to the closed-loop system, or during an emergency situation or a pipe leakage event; (d) to control or regular to modify the level or amount of electrical power that is produced by the system, or to increase it or decrease it, by adding or reducing (respectively) the amount of liquid that travels through the closed-loop system (e.g., to reduce the amount of liquid that travels through the system between 2 AM and 5 AM, which is a time-window in which most private consumers are asleep and most business consumers are non-operational and thus less electricity is needed to be produced); (e) to enable the generation of high-pressure injection or pushing or pressing or insertion of the liquid into the underground segment of the closed-loop pipe system, e.g., into the pipe segment 103A, which in turn would also increase the pressure of the steam coming upwardly through pipe segment 103C and/or entering the steam collector and/or passing through the turbine(s) as multiple communicating vessels.

In accordance with the present invention, storage tank 101 and the entirety of the closed-loop pipe system, utilize a fixed, finite, non-changing, non-increasing, non-decreasing, amount or weight of the specific liquid 199, which does not change and does not deplete and is entirely re-cycled and re-use repeatedly and continuously for numerous cycles throughout the closed-loop system (e.g., 100 cycles, 800 cycles, 15,000 cycles, 60,000 cycles, and virtually in perpetuity); without reduction or loss or leakage or escaping of the material from the closed-loop system, and without the need to add or to replenish or to re-stock or to replace the material (or any portion thereof) from an external source or reservoir. For example, in a demonstrative embodiment, a fixed and finite amount of 500 or 5,000 or 20,000 or 40,000 or 100,000 or 500,000 or 1,00,000 liters or 2 or 5 or 8 or 10 million liters of a specific liquid having a low boiling point of under 90 degrees Celsius (e.g., dichloromethane, ethanol, acetone, 1-pentene, Isopentane, Pentane, ethyl ether, ethylene oxide, propylene oxide, ethyl chloride, methyl Tert-Butyl ether) may be initially stored inside the storage tank 101, which may then be sealed such that the entirety of the closed-loop system is closed and sealed; and that finite and fixed amount of material rotates and cycles and re-cycles repeatedly through the closed-loop system, changing its state from liquid to gas and then back to liquid and then back to gas and so forth, while passing underground and while passing over-ground or-above ground, and while passing as vapors or gas or steam through turbine(s) that spin and rotate or move and generate electricity.

The closed-loop system of the present invention is at direct contrast with a conventional open-loop geothermal power system, which requires expensive and hazardous and cumbersome drilling to significantly deeper depths, and/or which require to be located at particular locations (e.g., in volcanic activity regions), and/or which utilize water or other substance that boils at high temperatures (e.g., that are equal to or greater than 90 degrees Celsius), and/or which allow the water or other substance that passes through a turbine to then evaporate into the atmosphere while requiring a replenishment or a new input of water (or other substance).

It is clarified that in accordance with the present invention, the storage tank 101, the injector 102, the steam collector 180, the turbines 131-133, and the optional Liquefication Unit/Chamber 126, are all integral and internal parts of the closed-loop system or of the closed-loop pipe system, and are not to be regarded as components that are external to such closed-loop system; as these components are pass-through components for the specific liquid 199, in its liquid form and/or in gas form and/or as steam and/or as vapor.

In some embodiments, the underground depth of the underground pipe sub-system 103 is not more than D meters, wherein D is a depth that is sufficient to cause underground boiling of a specific liquid having a boiling point that is under 90 degrees Celsius, but wherein D is smaller than 2,500 meters; or, wherein D is a depth that is sufficient to cause underground boiling of a specific liquid having a boiling point that is under 80 degrees Celsius, but wherein D is smaller than 2,500 meters; or, wherein D is a depth that is sufficient to cause underground boiling of a specific liquid having a boiling point that is under 70 degrees Celsius, but wherein D is smaller than 2,500 meters; or, wherein D is a depth that is sufficient to cause underground boiling of a specific liquid having a boiling point that is under 60 degrees Celsius, but wherein D is smaller than 2,500 meters; or, wherein D is a depth that is sufficient to cause underground boiling of a specific liquid having a boiling point that is under 55 degrees Celsius, but wherein D is smaller than 2,500 meters; or, wherein D is a depth that is sufficient to cause underground boiling of a specific liquid having a boiling point that is under 50 degrees Celsius, but wherein D is smaller than 2,500 meters; or, wherein D is a depth that is sufficient to cause underground boiling of a specific liquid having a boiling point that is under 45 degrees Celsius, but wherein D is smaller than 2,500 meters; or, wherein D is a depth that is sufficient to cause underground boiling of a specific liquid having a boiling point that is under 40 degrees Celsius, but wherein D is smaller than 2,500 meters.

In some embodiments, the underground depth of the underground pipe sub-system 103 is not more than 2,500 meters, and the liquid 199 is a liquid that has a boiling point that is lower than the underground temperature at said underground depth at the geographical location in which the system is constructed. In some embodiments, the underground depth of the underground pipe sub-system 103 is not more than 2,200 meters, and the liquid 199 is a liquid that has a boiling point that is lower than the underground temperature at said underground depth at the geographical location in which the system is constructed. In some embodiments, the underground depth of the underground pipe sub-system 103 is not more than 2,000 meters, and the liquid 199 is a liquid that has a boiling point that is lower than the underground temperature at said underground depth at the geographical location in which the system is constructed. In some embodiments, the underground depth of the underground pipe sub-system 103 is not more than 1,800 meters, and the liquid 199 is a liquid that has a boiling point that is lower than the underground temperature at said underground depth at the geographical location in which the system is constructed. In some embodiments, the underground depth of the underground pipe sub-system 103 is not more than 1,500 meters, and the liquid 199 is a liquid that has a boiling point that is lower than the underground temperature at said underground depth at the geographical location in which the system is constructed. In some embodiments, the underground depth of the underground pipe sub-system 103 is not more than 1,300 meters, and the liquid 199 is a liquid that has a boiling point that is lower than the underground temperature at said underground depth at the geographical location in which the system is constructed. In some embodiments, the underground depth of the underground pipe sub-system 103 is not more than 1,200 meters, and the liquid 199 is a liquid that has a boiling point that is lower than the underground temperature at said underground depth at the geographical location in which the system is constructed. In some embodiments, the underground depth of the underground pipe sub-system 103 is not more than 1,000 meters, and the liquid 199 is a liquid that has a boiling point that is lower than the underground temperature at said underground depth at the geographical location in which the system is constructed.

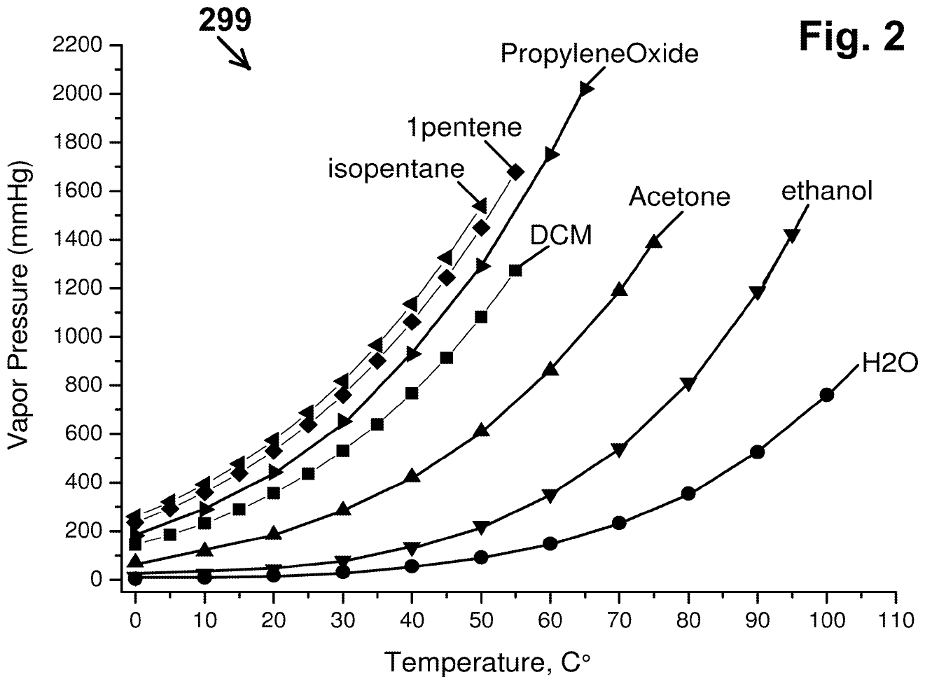

Reference is made to FIG. 2, which is a schematic block-diagram illustration of a chart 299 demonstrating the vapor pressure that may be generated for seven different materials at as a function of temperature, in accordance with some demonstrative embodiments of the present invention. The vertical axis indicates the vapor pressure in mmHg. The horizontal axis indicates temperature in degrees Celsius. The seven graph lines correspond to seven materials. As shown, water (H2O) is significantly inferior to the six other materials in terms of vapor pressure generated. Chart 299, or similar charts, may be utilized when constructing or implementing the system of the present invention, for example, in order to facilitate or to assist in the selection of the particular liquid that will be injected into the underground pipes sub-system, and/or to estimate or predict the output vapor pressure and to utilize suitable components (e.g., steam collectors, turbines, pipes) based on such vapor pressure. Other suitable charts may be generated; and the values and materials that appear in chart 200 are only non-limiting examples of a particular demonstrative embodiment.

The present invention may provide various advantages or benefits. For example, the system of the present invention utilizes underground geothermal heat to generate steam power of low boiling medium, thereby enabling to construct and maintain such system at almost any place on Earth and not only in specific geographical locations that are typically in volcanic activity regions and/or near sea shore (for cooling). Furthermore, after the initial installation of the system, no mining or transportation activity is required; and the electric power output of the geothermal plant can be accurately predicted. The system of the present invention is small-size relative to conventional power plants, and has a small or smaller footprint; and its construction and installation is easier, faster, less expensive, and having no or little environmental impact. The present invention is scalable and may be implemented at large scale, and/or may solve or mitigate the problem of depletion of non-renewable energy sources; rather, with geothermal energy there is no shortages which characterizes other energy sources.

The system of the present invention may thus be environmentally friendly; since it is based on a closed-loop, there are no pollution and no polluting aspects to traverse, and the carbon footprint of the geothermal power plant of the present invention is minimal.

The system of the present invention utilizes a renewable resource or a virtually endless resource, as geothermal reservoirs are naturally replenished and/or do not deplete; geothermal energy is extracted from Earth's core, and should be available for millions or even billions of years ahead without an “expiration date” associated therewith and without any “shortage of inventory”; in contrast to depleting fossil fuels which reduce in quantity and/or have their respective expiration dates.

The potential power generation capacity may be virtually unlimited in accordance with the present invention, since the systems may be deployed virtually anywhere and are not limited to only regions with geothermal activity and/or near the sea (for cooling).

The system of the present invention may utilize geothermal heat as a stable and predictable resource; and the power output of the geothermal power plant of the present invention may be accurately predicted or calculated, without being subject to unpredictable fluctuations that characterize some solar-based or wind-based power generation systems. Furthermore, since the geothermal resource is predictable and stable, the system of the present invention may generate electricity and provide based load and/or peak power. For example, modification, increase or decrease of the pressure in which the liquid is injected downwardly into the underground pipe segments, may be used in order to indirectly change, increase or decrease (respectively) the amount of electric power that is generated by the system, or the effective power production capacity of the system.

The system of the present invention may operate without any fuel consumption; such that, for example, after its initial installation, no mining or transportation activity is necessary or required. The system of the present invention may require a small land footprint, smaller than any conventional power plant of any type; and/or may be more economical to construct, to operate and/or to maintain, relative to conventional geothermal power plants and/or other types of power plants.

Furthermore, the closed-loop system of the present invention may obviate the need to spend money and resources on upwardly pumping of liquid(s) or water; for example, a conventional geothermal power station typically needs powerful and expensive pumps, which are also expensive to operate and to maintain, as such pumps are required in order to pump up back to the ground level the boiling water from significant depths of around 5,000 meters. In contrast, the particular unique structure of the system of the present invention, and its unique method of operation, obviate the need to install, maintain, or budget such pump(s).

The system of the present invention may solve or mitigate or avoid problems or disadvantages of conventional power generation plants. For example, drilling into large depths for extracting petroleum or for constructing a conventional geothermal power plant increases the risk of releasing greenhouse gas or other emissions from below Earth's surface and causing them to surface and to be introduced into the atmosphere; such emissions may be higher near conventional geothermal power plants, which are associated with sulfur dioxide and silica emissions; additionally or alternatively, some deep geothermal reservoirs or deep drilling may cause surfacing of traces of toxic heavy metals such as mercury, arsenic, and boron; the much shorter depth of drilling that is utilized to construct the closed-loop geothermal power plant of the present invention decreases such risks and hazards or avoids them.

The shorter depth of drilling in order to exercise the present invention, further reduces the risk of causing surface instability; for example, drilling 5,000 meters into the ground for constructing a conventional geothermal power plant in the year 2007 in Switzerland caused an earthquake with a magnitude of 3.4 on the Richter scale and further caused additional tremors, and that facility had to be abandoned shortly afterwards. In contrast, the system of the present invention requires and/or utilizes shorter depth of underground drilling and equipment, in the range of 1,000 or 1,500 or 2,000 or up to 2,500 meters below ground level, thereby reducing or minimizing such risks or instability or other hazards.

The present invention need not necessarily require a particular geographical location and/or access to a deeply-buried geothermal reservoir; but rather, may be implemented and constructed in any area, including at non-volcanic regions, near urban areas and cities (and thus avoiding or reducing or minimizing the cost to distribute the electricity from the power plant to consumers), in or next to highly-populated areas, away from (or without access to) a sea-shore or other body of water. Additionally, the system of the present invention need not be constructed or located in volcanic regions; and is thus not exposed or less exposed to the risks and hazards of volcanic activity; for example, in contrast to a conventional geothermal power plant, such as the “Puna” power plant on the Big Island of Hawaii which was extremely close to the eruption of the Kilauea volcano in May 2018. The removal of requirement for a specific geographic location, allows to construct

Furthermore, a conventional geothermal power plant requires specially designed heating and cooling systems and other equipment that can withstand high temperatures and/or long depth of drilling into the ground; and are typically constructed at isolated or non-urban or rural areas, which in turn increases the cost to transport equipment there and to distribute the generated electricity to consumers. Additionally, despite being considered a sustainable and renewable energy, there exist a risk or a chance that a specific location chosen for a conventional geothermal power plant might cool down after time, making it impossible to later harvest more geothermal energy in the already-constructed facility at that particular location. In contrast, the system of the present invention utilizes lower heat and lower boiling point liquids; and, for example, in some embodiments of the present invention, the vapor pressure of the liquid is twice than water at 45 degrees Celsius, such that twice the amount of electric power may be generated by the system of the present invention relative to a conventional water-based geothermal system. Furthermore, less cooling sub-systems are used by the power generation system of the present invention; or, in some embodiments, no cooling sub-systems are needed at all; and therefore, power plant area that would typically be used for cooling equipment or purposes, may be replaced by or may be populated by additional turbines and/or by additional close-loop systems that operate in parallel to each other.

In some embodiments of the present invention, a low boiling point medium is used in a geothermal closed loop system, characterized by one single pipe going deep underground where temperature is high enough to boil the medium; and the medium returns back to the ground level with high steam pressure which in turns rotates or moves or powers a turbine connected to an electricity generator that generates electrical power. The medium is then re-cycled and re-used in the same closed loop system, without materials escaping or leaking or otherwise being lost. In some embodiments, the medium may be one or more materials selected from the group of materials mentioned above. The low boiling point medium is inserted or injected underground through a closed looped pipe, and returns to ground level as a high pressure steam. The outlet is connected to a steam collector. The steam which arrives from the underground pipe goes through the steam collector, which is connected to a steam turbine associated with an electric power generator. The steam then continues to turn or spin or rotate other turbine generator(s), one after the other, until the vapors cool down and liquefy or turn back to liquid state; and the liquid is collected in a reservoir and is transferred to be re-used again through the same closed loop pipe system, in a generally continuous cycle.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A system for generating electricity, the system comprising:
a storage tank to store a specific liquid, wherein the specific liquid has a boiling point of under 90 degrees Celsius;
a closed-loop pipe sub-system, which penetrates underground to a depth of between 1,000 to 2,500 meters, and transports therein said specific liquid downwardly underground and then upwardly back towards ground level, and causes at least a portion of said specific liquid to boil underground due to proximity to a natural geothermal heat source;
at least one turbine associated with an electric power generator, connected above ground level to said closed-loop pipe sub-system, to receive steam that results in from underground boiling of said specific liquid, to pass said steam through said turbine, and to generate electric power through said electric power generator.

2. The system of claim 1,
wherein steam output from said at least one turbine is transported back, through said closed-loop pipe sub-system, to said storage tank; and is liquified and then repeatedly and continuously re-used in said closed-loop pipe sub-system.

3. The system of claim 1,
wherein steam output from said at least one turbine is transported to at least a second turbine, and passes through said second turbine which generates additional electricity via a second electric power generator;
wherein steam output from said second turbine is transported back, through said closed-loop pipe sub-system, to said storage tank; and is liquified and then repeatedly and continuously re-used in said closed-loop pipe sub-system.

4. The system of claim 1,
wherein said closed-loop pipe sub-system comprises a steam collector that collects high-pressure steam of said liquid that was boiled underground, and routes said high-pressure steam towards said at least one turbine.

5. The system of claim 1,
wherein said closed-loop pipe sub-system comprises a steam collector that collects high-pressure steam of said liquid that was boiled underground, and routes said high-pressure steam towards said at least one turbine;
wherein said steam collector comprises a diverter and separator unit, to separate between said high-pressure steam and liquid vapors incoming from underground, and to route said liquid vapors directly towards said storage tank in a transport route that excludes any turbines.

6. The system of claim 1, comprising:
one or more pipe segments to transport steam, that is generated in said closed-loop pipe sub-system due to underground boiling of said specific liquid, through a plurality of turbines, one turbine after another turbine; wherein a subsequent turbine receives as input the steam that is outputted after passing through a previous turbine;
one or more additional pipe segments to transport a steam output of the last turbine of said turbines, back to said storage tank.

7. The system of claim 1, comprising:
one or more pipe segments to transport steam, that is generated in said closed-loop pipe sub-system due to underground boiling of said specific liquid, through a plurality of turbines, one turbine after another turbine; wherein a subsequent turbine receives as input the steam that is outputted after passing through a previous turbine;
one or more additional pipe segments to transport a steam output of the last turbine of said turbines, to a liquefaction chamber that converts said steam output to liquid and that outputs said liquid to be transported back to said storage tank.

8. The system of claim 1, comprising:
an injector to receive said specific liquid from said storage tank, and to inject said specific liquid at a pressure into a downward-transporting pipe-segment of said closed-loop sub-system;
wherein said storage tank and said injector are parts of said closed-loop sub-system.

9. The system of claim 1,
wherein said specific liquid has a boiling point of under 45 degrees Celsius.

10. The system of claim 1,
wherein said specific liquid is a single liquid selected from the group consisting of:
dichloromethane, ethanol, acetone.

11. The system of claim 1,
wherein said specific liquid is a single liquid selected from the group consisting of:
dichloromethane, ethanol, acetone,
1-pentene, Isopentane, Pentane,
ethyl ether, ethylene oxide, ethyl chloride,
propylene oxide, methyl Tert-Butyl ether.

12. The system of claim 1,
wherein said specific liquid comprises a mixture of two or more liquids selected from the group consisting of:
dichloromethane, ethanol, acetone,
1-pentene, Isopentane, Pentane,
ethyl ether, ethylene oxide, ethyl chloride,
propylene oxide, methyl Tert-Butyl ether.

13. The system of claim 1,
wherein said system excludes a cooling tower and operates without requiring a cooling tower;
wherein said system excludes a pump that pumps said specific liquid upwardly back to ground level.

14. The system of claim 1,
wherein said system is capable of operating and generating electricity at a non-volcanic region of Earth.

15. The system of claim 1,
wherein said system is capable of operating and generating electricity at a geographical region that is not adjacent to any body of water.

16. The system of claim 1,
wherein the specific liquid is continuously and repeatedly re-used within said closed-loop pipe sub-system without being in direct touch with above-ground air or with under-ground geosphere.

17. The system of claim 1,
wherein the specific liquid is a specific liquid having a pre-defined finite and fixed volume as liquid which continuously and repeatedly re-cycles within said closed-loop pipe sub-system, continuously and repeatedly alternating its state between liquid and steam, without evaporating to the atmosphere, and without being replenished from any external source between consecutive cycles.

18. The system of claim 1,
wherein the closed-loop pipe sub-system is formed of a thermally conductive material, and wherein travel of said specific liquid to a full underground depth of said closed-loop pipe sub-system causes said specific liquid to boil underground and to convert to steam.

19. The system of claim 1,
wherein the specific liquid has a boiling point of under 57 degrees Celsius;
wherein travel of said specific liquid at an underground depth of up to 2,500 meters within said closed-loop pipe sub-system causes said specific liquid to boil underground and to convert to steam.

20. A method for generating electricity, the method comprising:
storing in a storage tank a specific liquid which has a boiling point of under 90 degrees Celsius;
transporting said specific liquid through a closed-loop pipe sub-system, which penetrates underground to a depth of between 1,000 to 2,500 meters, and transports therein said specific liquid downwardly underground and then upwardly back towards ground level; and causing at least a portion of said specific liquid to boil underground due to proximity to a natural geothermal heat source;
receiving steam that results in from underground boiling of said specific liquid, and passing said steam through at least one turbine associated with an electric power generator, connected above ground level to said closed-loop pipe sub-system, wherein said steam rotates said at least one turbine which generate electric power through said electric power generator;
transporting back steam output from said at least one turbine, through said closed-loop pipe sub-system, to said storage tank; liquifying said steam into said specific liquid, and then repeatedly and continuously re-using said specific liquid in said closed-loop pipe sub-system.
